(19) United States
(12) Patent Application Publication
(10) Pub. No.: US 2005/0203993 A1
(43) Pub. Date: Sep. 15, 2005

(54) System and method for optimizing data store selection for write operations

(76) Inventors: Steven L. Grobman, El Dorado Hills, CA (US); Craig T. Owen, Folsom, CA (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/750,170

(22) Filed: Dec. 31, 2003

(51) Int. Cl. G06F 12/00

(52) U.S. Cl. 709/203; 711/141

(57) ABSTRACT

A system and method for optimizing data store selection for write operations are described herein. In one embodiment the method includes receiving a first request to perform a write operation on one of a plurality of multi-master data stores, wherein the one of the plurality of multi-master data stores is undetermined, and wherein the first request includes an optimization technique identifier. The method also includes creating a second request, wherein the second request requests performance of the write operation. The method further includes determining the one of the plurality of multi-master data stores to which the second request will be transmitted, and wherein the determining includes using an optimization technique associated with the optimization technique identifier. The method further includes transmitting the second request to the one of the plurality of multi-master data stores.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of data processing and more particularly to processing data on multi-master data stores.

### BACKGROUND

Directories are databases which typically store information about objects that exist in a physical environment. For example, directories often store information about people, computers, automobiles, etc. Directories are typically implemented on a number of widely distributed multi-master servers, where each multi-master server includes a replica of the directory data. For multi-master directory systems, directory modifications can be made to any of the multi-master servers. After one or more of the multi-master servers is modified, data inconsistencies are resolved across all the multi-master servers.

One prior art method for reducing latencies associated with modifying multi-master directories calls for modifying a directory replica stored on the closest multi-master directory server. For example, assume that a multi-master directory system includes a New York directory server and a Colorado directory server. If a California user modifies the directory, the modifications are stored on the Colorado directory server until directory modifications are replicated between the New York and Colorado servers. Because directory modifications are not simultaneously performed on all multi-master servers, there can be long delays from the time a multi-master server is modified until when the modifications are recorded across all multi-master servers. One disadvantage of this prior art method is that certain users (e.g., users who do not have access to the first-modified directory server) cannot access modified data until modifications are replicated to the server that they are accessing.

### BRIEF DESCRIPTION OF THE FIGURES

The present invention is illustrated by way of example and not limitation in the Figures of the accompanying drawings in which:

FIG. 1 illustrates an exemplary computer system used in conjunction with certain embodiments of the invention;

FIG. 2 is a block diagram illustrating a network-based system for optimizing directory write operations, according to exemplary embodiments of the invention;

FIG. 3 is a code segment of a DSML request, according to exemplary embodiments of the invention;

FIG. 4 is a flow diagram illustrating a method performed by a client for creating a directory server write request using DSML, according to exemplary embodiments of the invention;

FIG. 5 is a flow diagram illustrating a method performed by a client for creating a transaction requests using an API;

FIG. 6 is a flow diagram illustrating operations performed by a DSML server for transmitting a directory write request to a directory server, according to exemplary embodiments of the invention;

FIG. 7 is a flow diagram illustrating operations for determining a directory server to which a write request will be transmitted;

FIG. 8 is a flow diagram illustrating operations performed by a DSML server for determining an optimization technique; and

FIG. 9 is a flow diagram describing operations for processing a directory write requests, according to embodiments of the invention.

### DESCRIPTION OF THE EMBODIMENTS

Systems and methods for optimizing data store selection for write operations are described herein. In the following description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Moreover, it should be understood that although the flow diagrams depict serial operations, certain embodiments could perform certain of those operations in parallel.

This description of the embodiments is divided into two sections. In the first section, an exemplary hardware and operating environment is described. In the second section, an exemplary implementation is described.

### Hardware and Operating Environment

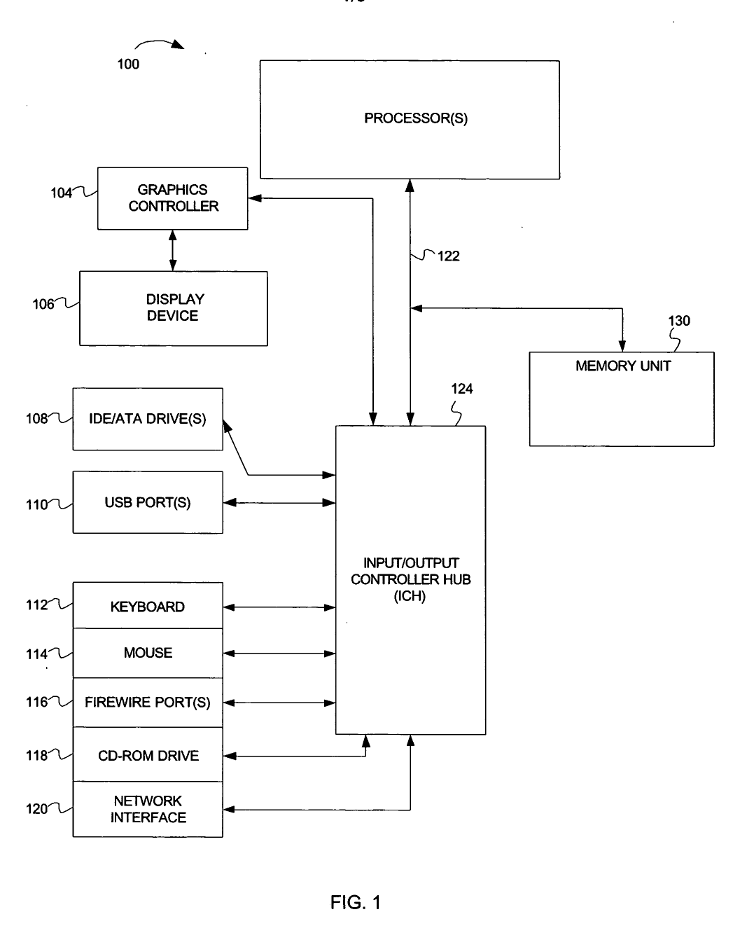

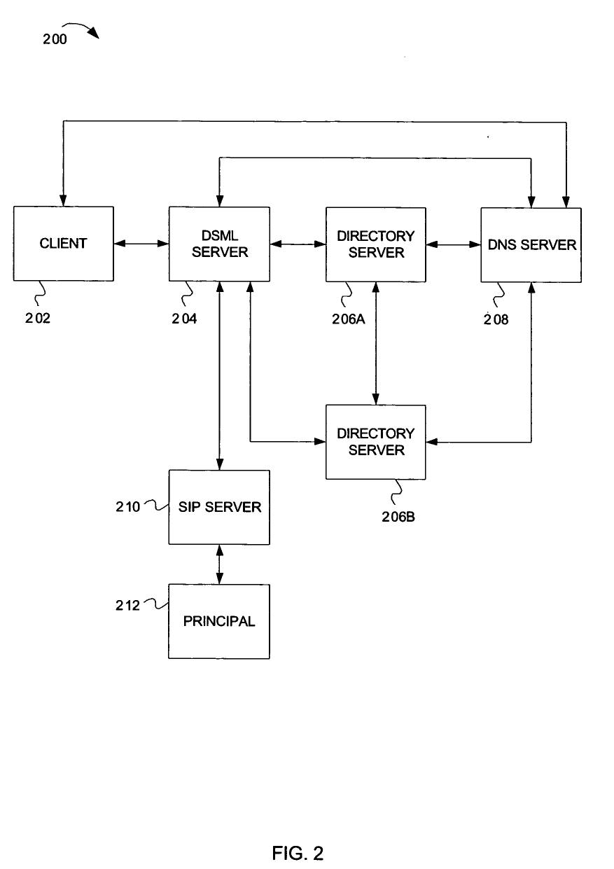

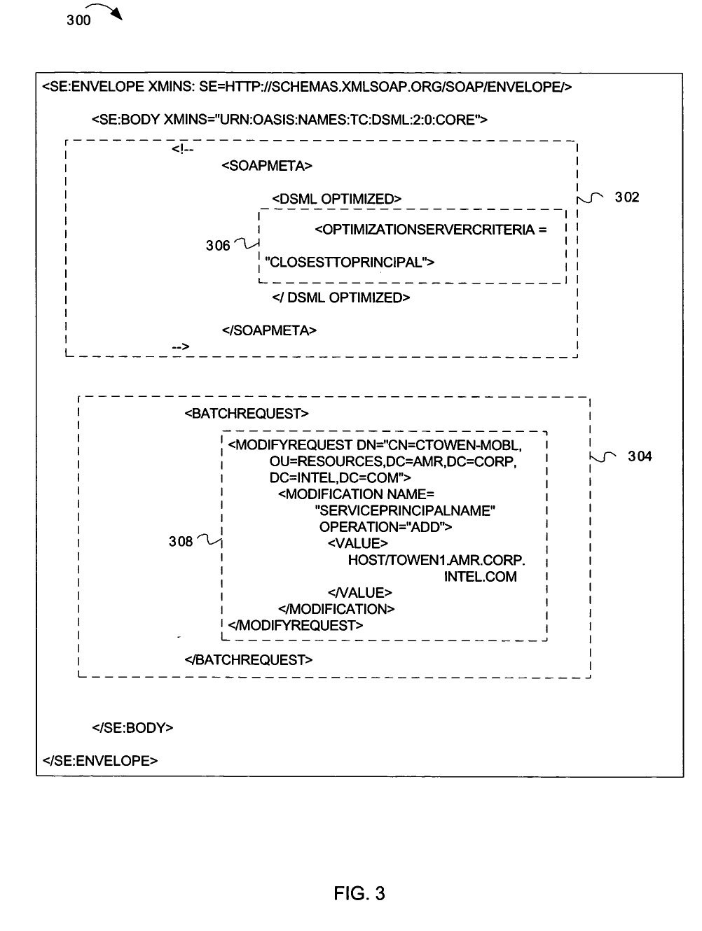

This section provides an overview of the exemplary hardware and an operating environment in which embodiments of the invention can be practiced. FIG. 1 describes an exemplary computer system used with embodiments of the invention, while FIG. 2 describes network-based components used with embodiments of the invention. The functionality of the network-based components will be described below in a series of flow diagrams (see FIGS. 3-8, which are discussed in the next section).

FIG. 1 illustrates an exemplary computer system used in conjunction with certain embodiments of the invention. As illustrated in FIG. 1, computer system 100 comprises processor(s) 102. The computer system 100 also includes a memory unit 130, processor bus 122, and Input/Output controller hub (ICH) 124. The processor(s) 102, memory unit 130, and ICH 124 are coupled to the processor bus 122. The processor(s) 102 may comprise any suitable processor architecture. The computer system 100 may comprise one, two, three, or more processors, any of which may execute a set of instructions in accordance with embodiments of the present invention.

The memory unit 130 stores data and/or instructions, and may comprise any suitable memory, such as a dynamic random access memory (DRAM), for example. The computer system 100 also includes IDE drive(s) 108 and/or other suitable storage devices. A graphics controller 104 controls the display of information on a display device 106, according to embodiments of the invention.

The input/output controller hub (ICH) 124 provides an interface to I/O devices or peripheral components for the computer system 100. The ICH 124 may comprise any suitable interface controller to provide for any suitable communication link to the processor(s) 102, memory unit 130 and/or to any suitable device or component in communication with the ICH 124. For one embodiment of the invention, the ICH 124 provides suitable arbitration and buffering for each interface.

For one embodiment of the invention, the ICH 124 provides an interface to one or more suitable integrated drive electronics (IDE) drives 108, such as a hard disk drive (HDD) or compact disc read only memory (CD ROM) drive, or to suitable universal serial bus (USB) devices through one or more USB ports 110. For one embodiment, the ICH 124 also provides an interface to a keyboard 112, a mouse 114, a CD-ROM drive 118, one or more suitable devices through one or more firewire ports 116. For one embodiment of the invention, the ICH 124 also provides a network interface 120 though which the computer system 100 can communicate with other computers and/or devices. In one embodiment, the computer system 100 includes a machine-readable medium that stores a set of instructions (e.g., software) embodying any one, or all, of the methodologies for optimizing data store selection for write operations. Furthermore, software can reside, completely or at least partially, within memory unit 130 and/or within the processor(s) 102.

FIG. 2 is a block diagram illustrating a network-based system for optimizing directory write operations, according to exemplary embodiments of the invention. In the following discussion of FIG. 2, the functionality of each system component will be generally described. However, a detailed description of each component's functionality is given in the next section.

As shown in FIG. 2, the system 200 includes a client 202, which is connected to a Directory Services Markup Language (DSML) server 204. The DSML server 204 is also to connected a Session Initiation Protocol (SIP) server 210, directory servers 206A-B, and a Domain Name System (DNS) server 208. The SIP server 210 is connected to a principal 212. The directory servers 206A-B are also connected to the DNS server.

According to embodiments of the invention, the components (e.g., the client 202, DSML server 204, etc.) of the system 200 can be integrated or divided, forming a lesser or greater number of components. For example, the functionality of the client 202 and the DSML server 204 can be combined into one component. According to embodiments, the components can include data structures necessary for performing the functionality described herein. Additionally, the functional units can be connected using any suitable physical media (e.g., copper, fiber-optic media, etc.). Alternatively, the components can be connected using wireless technology. The components can communicate with each other using any suitable communication method (packet switched protocols, circuit switched protocols, etc.). Any of the components used in conjunction with embodiments of the invention can include machine-readable media for performing operations described herein. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.), etc. According to embodiments of the invention, the functional units can be other types of logic (e.g., digital logic) for executing the operations for optimizing multi-master write operations described herein.

In one embodiment, the client 202 is a network application, which receives directory write requests from a user through a graphical user interface or other initiating process. After receiving the directory write requests, the client 202 transmits the directory write requests to the DSML server 204 in the form of a DSML request.

In one embodiment, the DSML server 204 receives the DSML requests (i.e., the directory write requests) from the client 202. The DSML server 204 can be hardware or software that receives and processes DSML requests. The DSML server converts the DSML requests into Lightweight Directory Access Protocol (LDAP) requests, each of which contains a directory write request. Based on an optimization technique identifier contained within the DSML request, the DSML server selects one of the directory servers 206A-B to which it will transmit the LDAP request. The DSML server then transmits the LDAP requests to the chosen directory server 206A-B.

In one embodiment, the DSML server 204 uses the DNS server 208 to locate an object or caller, where a caller is a computer that is calling or using a client, and where an object is a physical object such as a computer. When the DSML server 208 receives a DSML request, the DSML request includes information about the computer from which the DSML request was sent and/or information about an object that will be affected by the directory write request. The DSML server 204 uses this information and network address information provided by the DNS server 204 to determine the network address of the object or caller.

In one embodiment, the DSML server 204 uses the SIP server 210 to locate a principal, where a principal is a person or a computer. As noted above, DSML requests include information about the computer from which the DSML request were transmitted. The DSML server 204 uses the SIP server 210 to find the network address of a principal or object. For example, the DSML server 204 calls the SIP server 204 to locate a principal by determining the network address at which the principal is or was last logged-in.

According to embodiments, the directory servers 206A-B can be any suitable directory servers, such as Open LDAP, Novel Edirectory, Microsoft Active Directory, IBM Directory Server, etc. According to alternative embodiments, flat file databases, relational databases, hierarchical databases or any other suitable data store type can be substituted for the directory servers 206A-B.

### Exemplary Operations

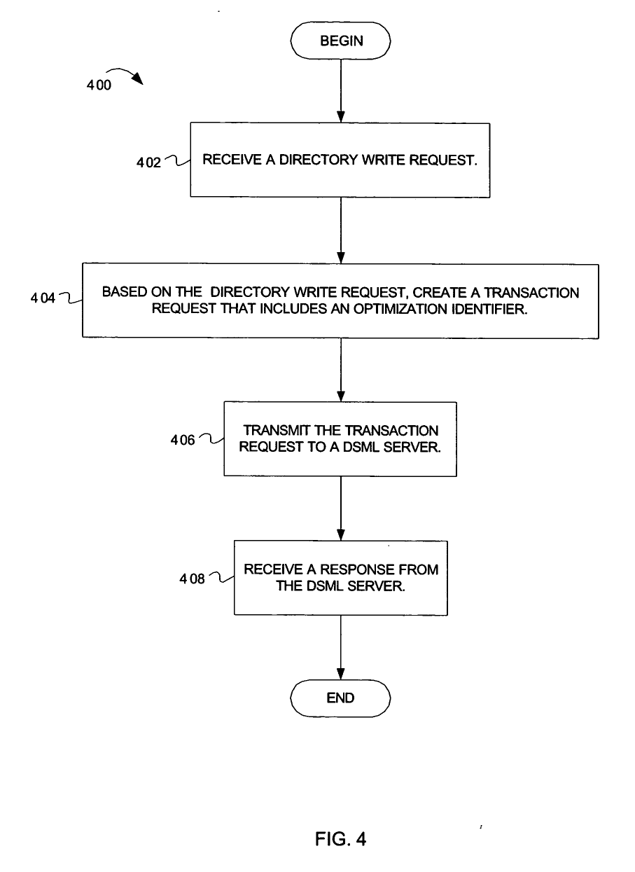

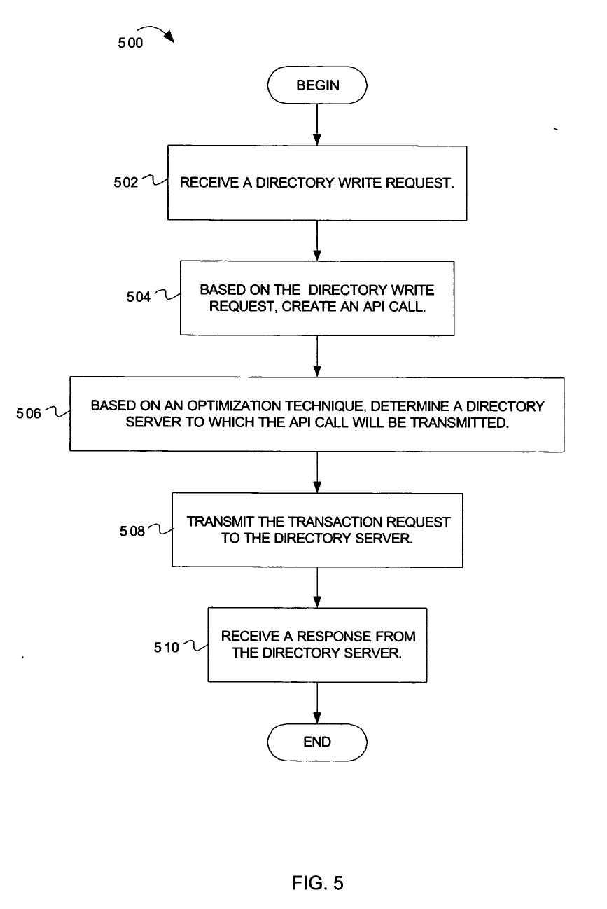

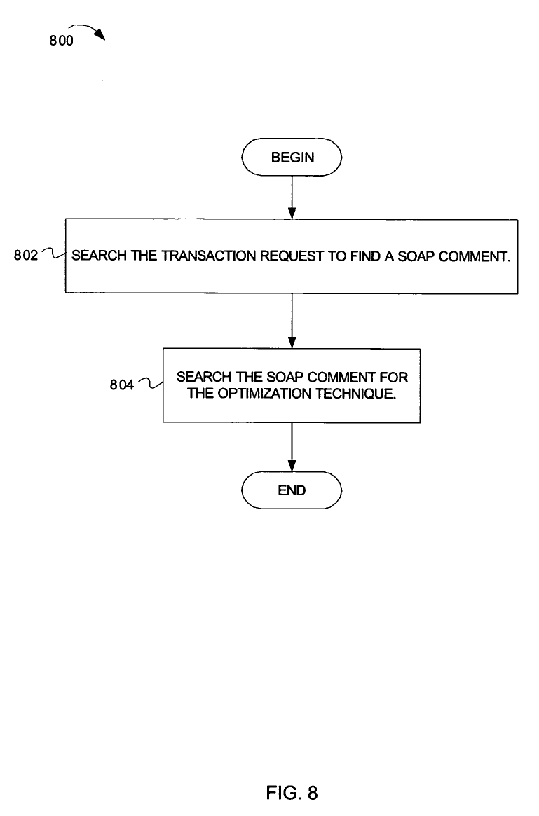

This section will describe exemplary operations performed by embodiments of the invention. In particular, FIG. 3 will describe an exemplary DSML request. FIGS. 4-5 describe operations performed by a client, while FIGS. 5-7 describe operations performed by a DSML server. FIG. 8 will describe operations performed by the directory servers.

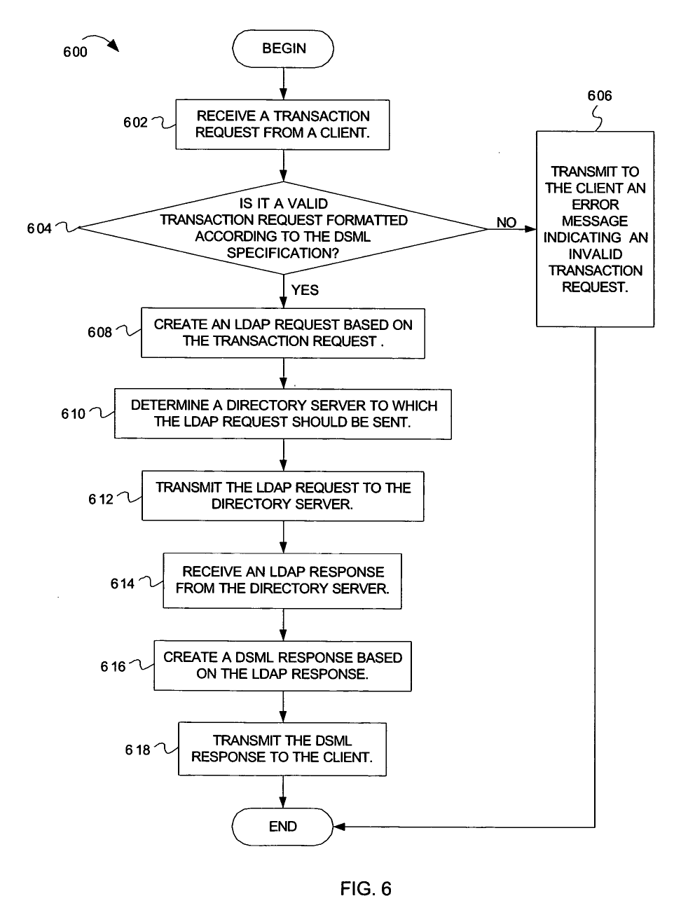

FIG. 3 is a code segment of a DSML request, according to exemplary embodiments of the invention. As shown in FIG. 3, the code segment 300 includes a SOAP comment 302 and a batch request 304. The SOAP comment 302 includes an optimization technique identifier 306, while the batch request 304 includes a write request 308. The optimization technique identifier 306 is used to indicate a specific technique for choosing a directory server to which the write request 308 will be transmitted. Techniques for choosing a directory server will be described below, in the discussion of FIG. 6. Because the optimization technique identifier 306 is contained within the SOAP comment 302, the format of the DSML request does not violate the DSML specification. Furthermore, these DSML requests will not cause errors in DSML servers that do not support the various optimization techniques described herein. As shown here, the write request 308 is a request to modify a directory object. The write request 308 adds an attribute named “serviceprincipalname” and assigns the attribute a value of “HOST/ctowen1.amr.corp.intel.com”.

As described above, optimization technique identifiers can be included in DSML SOAP comments. However, alternative embodiments call for extending the DSML specification to include support for optimization technique identifiers. Such an extension would enable DSML servers to process optimization technique identifiers without requiring that they be included in SOAP comments.

FIG. 4 is a flow diagram illustrating a method performed by a client for creating a directory server write request using DSML, according to exemplary embodiments of the invention. The flow diagram 400 will be described with reference to the exemplary system shown in FIG. 2 and the exemplary DSML request of FIG. 3.

The flow diagram 400 commences at block 402, wherein a client receives a directory write request. In one embodiment a write request is a request to add, modify or delete an object in a directory server or other data store. The flow continues at block 404.

At block 404, based on the write request, the client creates a transaction request that includes an optimization technique identifier. In one embodiment, the transaction request is formatted according to the DSML specification. For example, the client 202 creates a transaction request similar to the code segment 300 of FIG. 3. The flow continues at block 406.

At block 406, the client transmits the transaction request to a DSML server. The flow continues at block 408.

As shown in block 408, the client receives a response from the DSML server. From block 408, the flow ends.

While the discussion of FIG. 4 described a method for creating a transaction request using DSML, the discussion of FIG. 5 will setout an alternative method performed by a client for creating a transaction request using data store using Application Programming Interface (API) calls instead of DSML.

FIG. 5 is a flow diagram illustrating a method performed by a client for creating a transaction requests using an API. The flow diagram 500 will be described with reference to the exemplary system of FIG. 2. The flow diagram 500 commences at block 502, wherein the client receives a directory write request. The flow continues at block 504.

At block 504, based on the directory write request, the client creates an API call. In one embodiment, the client creates an API call using LDAP (e.g., the client creates an LDAP request). Alternative embodiments call for using any suitable data store API, such as APIs for accessing relational databases, flat file databases, hierarchical databases, etc. The flow continues at block 506.

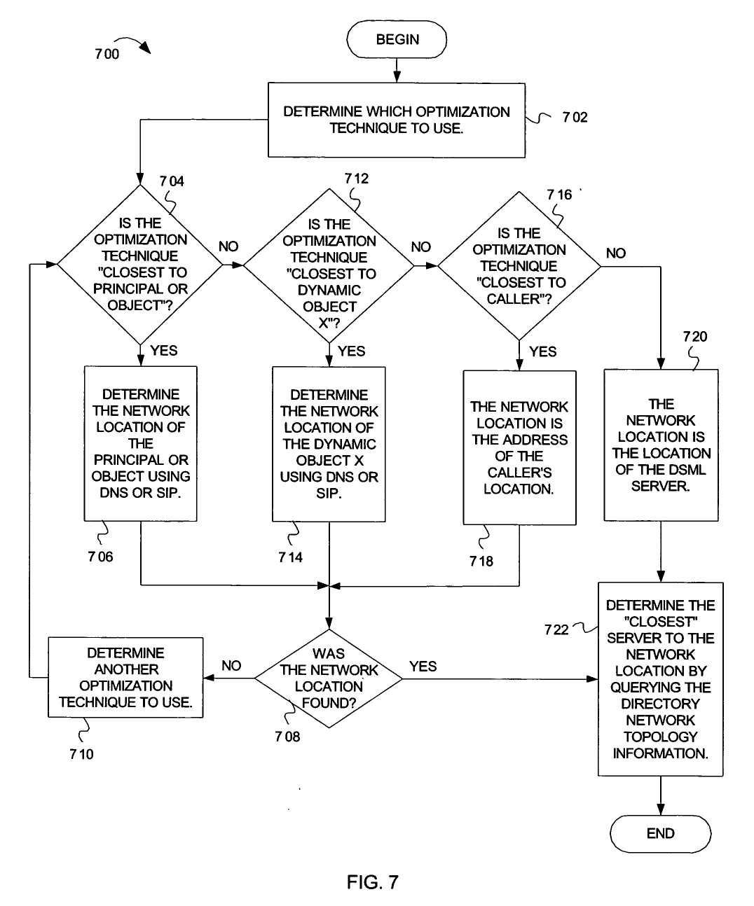

At block 506, based on an optimization technique, the client determines the directory server to which the API call will be transmitted. Optimization techniques for choosing one of a set of multi-master servers to which the API call will be transmitted are described below, in the discussion of FIG. 7. The flow continues at block 508.

At block 508, the client transmits the transaction request to the directory server. In an alternative embodiment, the client transmits the transaction request to a data store, such as a flat file database, hierarchical database, relational database, etc. The flow continues at block 510.

At block 510, the client receives a response from the directory server. In one embodiment, the response indicates whether the directory write request was performed successfully. In an alternative embodiment, the client receives a response from a data store (e.g., flat file database, hierarchical database, etc.). From block 510, flow ends. It should be understood that embodiments using the method described in FIG. 5 do not use the code segment of FIG. 2 and the methods of FIGS. 4, 6, and 8. However, those embodiments do employ the method described in FIG. 7.

While FIGS. 4-5 describe operations performed by a client, FIGS. 6-8 describe operations performed by a DSML server. In particular, FIG. 6 describes general operations for processing directory write requests, while FIGS. 7-8 describe certain DSML server operations in greater detail.

FIG. 6 is a flow diagram illustrating operations performed by a DSML server for transmitting a directory write request to a directory server, according to exemplary embodiments of the invention. The flow diagram 600 will be described with reference to the exemplary system shown in FIG. 2. The flow diagram 600 begins at block 602.

At block 602, the DSML server receives a transaction request (e.g., a DSML request including code similar to code segment 200) from a client. In one embodiment, the DSML server receives a plurality of transaction requests in one DSML request. For example, referring to FIG. 3, the batch request 304 can include a plurality of write requests 308. The flow continues at block 604.

At block 604, the DSML server determines if the transaction request is valid and formatted according to the DSML specification. If the transaction request is invalid or not formatted according to the DSML specification, the flow continues at block 606. Otherwise the flow continues at block 608.

At block 606, the DSML server transmits to the client an error message indicating an invalid transaction request. From block 606, the flow ends.

At block 608, the DSML server creates an LDAP request based on the transaction request. In one embodiment, the DSML server creates a plurality of LDAP requests based on a plurality of transaction requests received in a DSML request. In one embodiment, the DSML server could substitute DSML requests for LDAP requests. Thus, the operations of FIG. 6 could use DSML requests instead of LDAP requests. From block 608 the flow continues at block 610.

At block 610, the DSML server determines a directory server to which the LDAP request will be sent. According to embodiments, when a DSML request includes a plurality of transaction requests, the DSML server determines a directory server for each transaction request. Operations for determining a directory server to which the LDAP request will be sent are described in greater detail below, in the discussion of FIG. 7. The flow continues at block 612.

At block 612, the DSML server transmits the LDAP request to a directory server. The flow continues at block 614.

At block 614, the DSML server receives an LDAP response from the directory server. The flow continues at block 616.

At block 616, the DSML server creates a DSML response based on the LDAP response. The flow continues at block 618.

At block 618, the DSML server transmits the DSML response to the client. From block 618, the flow ends.

FIG. 7 describes the operation of block 610 of FIG. 6 in more detail. In particular, FIG. 7 describes operations for determining a multi-master data store to which a write request will be transmitted. Before describing those operations, the following optimization techniques for selecting a multi-master data store will be described: 1) closest to principal or object; 2) closest to dynamic object X; 3) closest to caller; 4) closest to DSML sever (or client).

According to the “closest to principal or object” optimization technique, directory write requests are transmitted to the one of a set of multi-master servers that is closest to a particular principal or object. This technique is typically used when the write request is modifying a directory object that represents the particular principal or object. Principals can be people, while objects can be any actual physical object. For example, consider a system administrator changing a user's password, which is stored in a directory. For each user of a computer system, there is a directory object that represents that user. This directory object contains a password attribute, which will be changed by a directory write operation. Replicas of this directory reside on a number of geographically distributed multi-master directory servers. The most effective place to update the password attribute is on the multi-master server that is closest to the user (not closest to the system administrator). Updating the multi-master server that is closest to the user allows the user to access the updated password without waiting for the multi-master servers to resolve differences between the directory replicas.

According to the “closest to dynamic object X” optimization technique, directory write requests are transmitted to the one of a set of multi-master servers that is closest to a particular principal or object. This technique is typically used when the directory write request is modifying, creating, or deleting a directory object (which may not yet exist) that does not represent the particular principal or object. For example, consider a system administrator creating a directory object representing a new computer that will be built for a user. Because the actual physical computer does not yet exist, the directory object cannot be created “closest to the object” (i.e., closest to the computer). Therefore, the most effective place to create the directory object that represents the user's new computer is on the multi-master server that is closest to the user (not the server closest to the system administrator). Updating the multi-master server that is closest to the user allows the user to join the new computer to the user's domain without waiting for the multi-master servers to resolve differences between the directory replicas.

According to the “closest to caller” optimization technique, directory write requests (e.g., requests to add, modify, or delete directory objects) are transmitted to the one of a set of multi-master servers that is closest to a caller. A caller is a principal or object that is calling a client. For example, consider a first user remotely accessing a web application to unlock a second user's account. In this example, the computer account is represented by a directory object. Additionally, in this example, the first and second users are in the same geographic location, while the web application resides a different location. The most effective place to modify the directory object that represents the second user's computer account is on the multi-master server that is closest to the first user, who is the caller of the web application.

FIG. 7 is a flow diagram illustrating operations for determining a directory server to which a write request will be transmitted. According to embodiments, the operations of the flow diagram 700 can be performed by a client (when the client is transmitting API calls) or a DSML server. The flow diagram 700 will be described with reference to the exemplary system of FIG. 2. The flow diagram 700 begins at block 702.

At block 702, the optimization technique to be used is determined. In one embodiment, a DSML server 204 determines the optimization technique based on an optimization technique identifier contained within a DSML SOAP comment. Operations for finding an optimization technique identifier within a DSML request are described in greater detail below, with reference to FIG. 8. The flow continues at block 704.

At block 704, it is determined whether the optimization technique is “closest to principal or object.” If the optimization technique is the “closest to principal or object,” the flow continues at block 706. Otherwise, continue at block 712.

At block 706, the network location of the principal or object is determined using DNS or SIP. For example, the DSML server 204 determines the network location of the principal or object by making calls to the DNS server 208 or the SIP server 210. In an alternative embodiment, the client 202 determines the network location of the principal or object by making calls to the DNS server 208 or the SIP server 210. In one embodiment, there are a plurality of principals or objects, so the DSML server 204 determines a plurality of network locations. The flow continues at block 708.

At block 708, it is determined whether the network location was found. If the network location was not found a flow continues at block 710. Otherwise the flow continues at block 722.

At block 710, another optimization technique is determined. From block 710, the flow continues at block 704.

At block 722, the closest server to the network location is determined by querying directory network topology information. In one embodiment, the DSML server 204 includes directory network topology information. Alternatively, the directory network topology information resides on a network computer accessible by the DSML server 204. From block 722, the flow ends.

At block 712, it is determined where the optimization technique is “closest to dynamic object X”. If the optimization technique is “closest to dynamic object X.” the flow continues at block 714. Otherwise the flow continues at block 716.

At block 714, the network location of the dynamic object is determined using DNS or SIP. For example, the DSML server 204 determines the network location of the dynamic object by making calls to the DNS server 208 or the SIP server 210. In an alternative embodiment, the client 202 determines the network location of the dynamic object by making calls to the DNS server 208 or the SIP server 210. From block 714, the flow continues at block 708.

At block 716, it is determined if the optimization technique is “closest to caller.” If it is determined that the optimization technique is “closest to caller,” the flow continues at block 718. Otherwise, the flow continues at block 720.

At block 718, it is determined that the network location is the address of the caller's location. From block 718, the flow continues at block 708.

At block 720, it is determined that the network location is the location of the DSML server. From block 720, the flow continues at block 722.

FIG. 8 is a more detailed description of the operation shown at block 702 of FIG. 7. In particular, FIG. 8 is a flow diagram illustrating operations performed by a DSML server for determining a technique for optimizing directory write operations. The flow diagram 800 begins at block 802.

At block 802, a transaction request is searched to find a SOAP comment. From block 802, the flow continues at block 804. At block 804 the SOAP comment is searched for an optimization technique identifier. For more details about the SOAP comment and the optimization technique identifier, see the discussion of FIG. 3 above. From block 804, the flow ends.

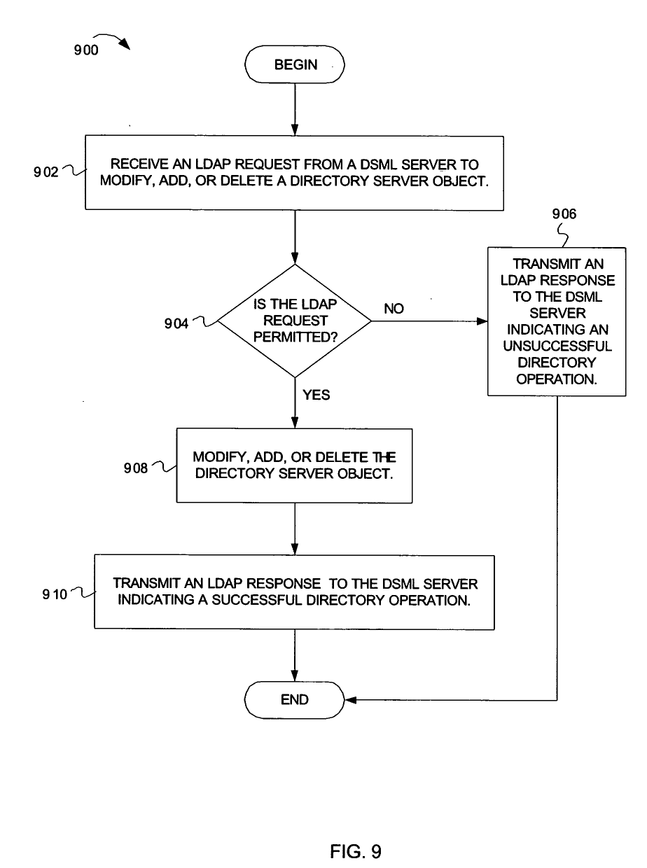

While FIGS. 6-8 describe operations performed by the DSML server 204 (or the client 202), FIG. 9 describes operations performed by a directory server or other data store.

FIG. 9 is a flow diagram describing operations performed by a directory server for processing a directory write request, according to embodiments of the invention. The flow diagram 900 begins at block 902.

At block 902 an LDAP request to modify, add, or delete a directory server object is received from a DSML server. In one embodiment, DSML requests and responses could be substituted for the LDAP requests and responses. Thus, in one embodiment, the operations of FIG. 9 can use either LDAP or DSML requests and responses. From block 902, the flow continues at block 904.

At block 904, it is determined whether the LDAP request is permitted. For example, the directory server (e.g., either of the directory servers 206A-B) determines whether the requestor has permission to modify the directory. If the LDAP request is permitted, the flow continues at block 908. Otherwise, the flow continues at block 906.

At block 908, the directory server object is modified, added, or deleted. For example, the directory server modifies, adds, or deletes a directory object that represents an object (e.g., a computer). From block 908, the flow continues at block 910.

At block 910, an LDAP response is transmitted to the DSML server indicating a successful directory operation. From block 910, the flow ends.

At block 906, an LDAP response to the DSML server indicating an unsuccessful directory operation is transmitted. From block 906, the flow ends.

Although the operations of FIG. 9 are described in terms of an LDAP directory server and a DSML server, embodiments of the invention call for similar operations performed by different system components. For example, requests and reply formatted according to a different APIs could be substituted for LDAP requests and replies. Additionally, operations performed by the DSML server could be performed by a client, as similarly noted above.

Thus, a system and method for optimizing data store selection for write operations have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
receiving a first request to perform a write operation on one of a plurality of multi-master data stores, wherein the one of the plurality of multi-master data stores is undetermined, and wherein the first request includes an optimization technique identifier;
creating a second request, wherein the second request requests performance of the write operation;
determining the one of the plurality of multi-master data stores to which the second request will be transmitted, and wherein the determining includes using an optimization technique associated with the optimization technique identifier; and
transmitting the second request to the one of the plurality of multi-master data stores.

2. The method of claim 1, wherein each of the plurality of multi-master data stores is a directory server.

3. The method of claim 1, wherein the first request includes code of the Directory Services Markup Language.

4. The method of claim 1, wherein the second request is formatted according to the Lightweight Directory Access Protocol.

5. The method of claim 1, wherein the first request includes additional optimization technique identifiers.

6. A method comprising:
receiving in a directory server a request to modify a directory, wherein the request is received from a Directory Services Markup Language (DSML) server, and wherein the DSML server selected the directory server based on an optimization technique associated with an optimization technique identifier included in a DSML request;
modifying the directory; and
transmitting a response to the DSML server, wherein the response indicates success of failure of the modification.

7. The method of claim 6, wherein the request is formatted according to the Lightweight Directory Access Protocol.

8. The method of claim 6, wherein the request is formatted according to the Lightweight Directory Access Protocol.

9. The method of claim 6, wherein the request is formatted according to the DSML.

10. The method of claim 6, wherein the optimization technique is selected from the set consisting of: closest to caller, closest to principal or object, and closest to dynamic object X.

11. A method comprising:
creating a first transaction request, wherein the first transaction request includes, an optimization technique identifier for determining to which one of a plurality of multi-master servers a second transaction request is transmitted;
transmitting the first transaction request to an intermediate server.

12. The method of claim 11, wherein the first transaction request includes Directory Services Markup Language code.

13. The method of claim 11, wherein the first transaction request includes a Simple Object Access Protocol (SOAP) comment, and wherein the SOAP comment includes the optimization technique identifier.

14. The method of claim 11, wherein the second transaction request is formatted according to the Lightweight Directory Access Protocol.

15. A method comprising:
selecting a first one of a set of geographically distributed multi-master data stores based on proximity of the first one to a first principal, a first object, or a first caller; and
transmitting a first write request to the first one of the set of geographically distributed multi-master data stores.

16. The method of claim 15, wherein each of the set includes a directory server.

17. The method of claim 15, wherein the first principal is a computer user.

18. The method of claim 15, wherein the first object is a computer.

19. The method of claim 15, wherein the first caller is remote application user.

20. The method of claim 15 further comprising:
selecting a second one of the set based on proximity of the second one to a second principal, a second object, or a second caller; and
transmitting a second write request to the second one of the set.

21. A method comprising:
receiving a DSML request, wherein the DSML request includes, an optimization technique identifier; and a first set of one or more directory server write requests;
creating a second set of one or more LDAP requests, wherein each of the LDAP requests includes at least one of the directory server write requests;
determining to which of a third set of geographically distributed multi-master directory servers the LDAP requests will be transmitted, wherein the determining includes using an optimization technique associated with the optimization technique identifier, and wherein the optimization technique selects those of the third set of multi-master servers based on a network location of one or more principals and one or more objects; and
transmitting ones of the second set of LDAP requests to ones of the third set of multi-master servers.

22. The method of claim 21, wherein the DSML request includes a secondary optimization technique identifier.

23. The method of claim 21, wherein the optimization technique identifier is located in a SOAP comment.

24. The method of claim 21, wherein the network location of the one or more principals and the one or more objects is determined using one or more of a set of network location services.

25. The method of claim 21, wherein the set of network location services include Session Initiation Protocol (SIP), Domain Name System (DNS), and Internet Locator Service (ILS).

26. A system comprising:
a processor;
a dynamic random access memory unit;
a machine readable medium including instructions for performing the following operations,
receiving in a directory server a request to modify a directory, wherein the request is received from a Directory Services Markup Language (DSML) server, and wherein the DSML server selected the directory server based on an optimization technique associated with an optimization technique identifier included in a DSML request;
modifying the directory; and
transmitting a response to the DSML server, wherein the response indicates success of failure of the modification.

27. The method of claim 26, wherein the request is formatted according to the Lightweight Directory Access Protocol.

28. The method of claim 26, wherein the second request is formatted according to the Lightweight Directory Access Protocol.

29. The method of claim 26, wherein the optimization technique is selected from the set consisting of: closest to caller, closest to principal or object, and closest to dynamic object X.

30. A machine-readable medium that provides instructions, which when executed by a machine, cause the machine to perform operations comprising:
receiving a first request to perform a write operation on one of a plurality of multi-master data stores, wherein the one of the plurality of multi-master data stores is undetermined, and wherein the first request includes an optimization technique identifier;
creating a second request, wherein the second request requests performance of the write operation;
determining the one of the plurality of multi-master data stores to which the second request will be transmitted, and wherein the determining includes using an optimization technique associated with the optimization technique identifier; and
transmitting the second request to the one of the plurality of multi-master data stores.

31. The machine-readable medium of claim 30, wherein each of the plurality of multi-master data stores is a directory server.

32. The machine-readable medium of claim 30, wherein the first request includes code of the Directory Services Markup Language.

33. The machine-readable medium of claim 30, wherein the second request is formatted according to the Lightweight Directory Access Protocol.

34. The machine-readable medium of claim 30, wherein the first request includes additional optimization technique identifiers.

35. A machine-readable medium that provides instructions, which when executed by a machine, cause the machine to perform operations comprising:
receiving in a directory server a request to modify a directory, wherein the request is received from a Directory Services Markup Language (DSML) server, and wherein the DSML server selected the directory server based on an optimization technique associated with an optimization technique identifier included in a DSML request;
modifying the directory; and
transmitting a response to the DSML server, wherein the response indicates success of failure of the modification.

36. The machine-readable medium of claim 35, wherein the request is formatted according to the Lightweight Directory Access Protocol.

37. The machine-readable medium of claim 35, wherein the request is formatted according to the Lightweight Directory Access Protocol.

38. The machine-readable medium of claim 35, wherein the request is formatted according to the DSML.

39. The machine-readable medium of claim 35, wherein the optimization technique is selected from the set consisting of: closest to caller, closest to principal or object, and closest to dynamic object X.

40. A machine-readable medium that provides instructions, which when executed by a machine, cause the machine to perform operations comprising:
creating a first transaction request, wherein the first transaction request includes, an optimization technique identifier for determining to which one of a plurality of multi-master servers a second transaction request is transmitted;
transmitting the first transaction request to an intermediate server.

41. The machine-readable medium of claim 40, wherein the first transaction request includes Directory Services Markup Language code.

42. The machine-readable medium of claim 40, wherein the first transaction request includes a Simple Object Access Protocol (SOAP) comment, and wherein the SOAP comment includes the optimization technique identifier.

43. The machine-readable medium of claim 40, wherein the second transaction request is formatted according to the Lightweight Directory Access Protocol.

44. A machine-readable medium that provides instructions, which when executed by a machine, cause the machine to perform operations comprising:
selecting a first one of a set of geographically distributed multi-master data stores based on proximity of the first one to a first principal, a first object, or a first caller; and
transmitting a first write request to the first one of the set of geographically distributed multi-master data stores.

45. The machine-readable medium of claim 44, wherein each of the set includes a directory server.

46. The machine-readable medium of claim 44, wherein the first principal is a computer user.

47. The machine-readable medium of claim 44, wherein the first object is a computer.

48. The machine-readable medium of claim 44, wherein the first caller is remote application user.

49. The machine-readable medium of claim 44 further comprising:
selecting a second one of the set based on proximity of the second one to a second principal, a second object, or a second caller; and
transmitting a second write request to the second one of the set.

50. A machine-readable medium that provides instructions, which when executed by a machine, cause the machine to perform operations comprising:
receiving a DSML request, wherein the DSML request includes, an optimization technique identifier; and a first set of one or more directory server write requests;
creating a second set of one or more LDAP requests, wherein each of the LDAP requests includes at least one of the directory server write requests;
determining to which of a third set of geographically distributed multi-master directory servers the LDAP requests will be transmitted, wherein the determining includes using an optimization technique associated with the optimization technique identifier, and wherein the optimization technique selects those of the third set of multi-master servers based on a network location of one or more principals and one or more objects; and
transmitting ones of the second set of LDAP requests to ones of the third set of multi-master servers.

51. The machine-readable medium of claim 50, wherein the DSML request includes a secondary optimization technique identifier.

52. The machine-readable medium of claim 50, wherein the optimization technique identifier is located in a SOAP comment.

53. The machine-readable medium of claim 50, wherein the network location of the one or more principals and the one or more objects is determined using one or more of a set of network location services.

54. The machine-readable medium of claim 50, wherein the set of network location services include Session Initiation Protocol (SIP), Domain Name System (DNS), and Internet Locator Service (ILS).
